(19) United States
(12) Patent Application Publication
(10) Pub. No.: US 2024/0171605 A1
(43) Pub. Date: May 23, 2024

(54) SCALABLE DARKWEB ANALYTICS

(71) Applicant: Qatar Foundation for Education, Science and Community Development, Doha (QA)

(72) Inventors: Yazan Boshmaf, Doha (QA); Isuranga Don, Doha (QA)

(21) Appl. No.: 18/386,486

(22) Filed: Nov. 2, 2023

Related U.S. Application Data
(60) Provisional application No. 63/426,243, filed on Nov. 17, 2022.

(51) Int. Cl. H04L 9/40; G06F 16/53; G06F 16/951

(52) U.S. Cl. CPC H04L 63/1441; G06F 16/53; G06F 16/951

(57) ABSTRACT

Scalable darkweb analytics are provided by crawling content offered by a plurality of onion services; sanitizing the content from each onion service of the plurality of onion services into sanitized content that represents potentially malicious content in a non-malicious form; storing, in a database, the sanitized content in association with a unique identity for each onion service of the plurality of onion services; receiving a request for information related to a given onion service of the plurality of onion services; and providing, in response to the request, the information based on the sanitized content

### CROSS-REFERENCES TO RELATED APPLICATIONS

The present disclosure claims the benefit of U.S. Provisional Patent Application No. 63/426,243 entitled “SYSTEMS AND METHODS FOR SCALABLE DARKWEB ANALYTICS” and filed on Nov. 17, 2022, which is incorporated herein by reference in its entirety.

### BACKGROUND

Onion services are private network services that are exposed over the Tor (“the onion router”) network, an overlay network that enables anonymous communication by not exposing identifying information of the users thereof, such as network location. As onion services are mainly used for website hosting, the anonymity onion services provide lends many onion servers to host illicit content, leading to the nickname, “the darkweb”. This illicit content hosting also has led onion services to be a valuable resource for security and privacy research as well as an area of interest for law enforcement and cybercrime prevention agencies. However, onion services have many unique properties that make it challenging to reliably find relevant content and to analyze that content. For example, as onion services are private by default, users have to discover onion services (or rather, onion domains—the unique address/Uniform Resource Locator (URL) of an onion service) by word of mouth or by surfing linked webpages, as opposed to using a traditional search engine. Additionally, many onion services host illicit content, which is illegal to store, making analysis of onion services challenging.

### SUMMARY

The present disclosure provides new and innovative systems and methods for analyzing onion services. The present disclosure provides for an onion services analysis system containing an onion services analysis model. An onion services analysis model may include a crawling pipeline, an analysis pipeline, distributed datastores, and an application module. The crawling pipeline includes crawlers that use a cluster of auto-scaling Tor clients to access the Tor network and extract information from visited onion domains. For each crawled onion domain, this extracted information is stored in raw form in the distributed datastores, and the extracted information is also used to render a version of the crawled onion domain, which is also stored in the distributed datastores. The analysis pipeline may include modules that classify onion domains, using the stored information in the distributed datastores, based on a property of interest, such as the language of the onion domain, whether the onion domain hosts illicit content, or whether the onion domain has an associated cryptocurrency address. Additionally, an analysis pipeline may include a graph intelligence module to graph the connections between crawled onion domains and the hosted content thereof. An application module may host one or more applications that use the information stored in the distributed datastores. These applications may include analytical search engines and collaboration laboratories. The resultant system is an onion services analysis system capable of extracting and storing a large scale amount of information from onion services, classifying the crawled onion domains and content thereof based on a property of interest, and using the stored data to support analytical applications such as an analytical search engine of darkweb onion domains.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 illustrates a computing device as may be uses as an onion service analysis system, according to aspects of the present disclosure.

FIG. 2 illustrates an example embodiment of an onion service analysis model according to embodiments of the present disclosure.

FIG. 3 is a flowchart of an example method of providing scalable darkweb analytics, according to embodiments of the present disclosure.

### DETAILED DESCRIPTION

The present disclosure provides a new and innovative methods and systems for the analysis of onion services. The present disclosure provides for an onion services analysis system containing an onion services analysis model. An onion services analysis model may include a crawling pipeline, an analysis pipeline, distributed datastores, and an application module. The crawling pipeline includes crawlers that use a cluster of auto-scaling Tor clients to access the Tor network and extract information from visited onion domains. For each crawled onion domain, this extracted information is stored in raw form in the distributed datastores, and the extracted information is also used to render a version of the crawled onion domain, which is also stored in the distributed datastores. The analysis pipeline may include modules that classify onion domains, using the stored information in the distributed datastores, based on a property of interest, such as the language of the onion domain, whether the onion domain hosts illicit content, or whether the onion domain has an associated cryptocurrency address. Additionally, an analysis pipeline may include a graph intelligence module to graph the connections between crawled onion domains and the hosted content thereof. An application module may host one or more applications that use the information stored in the distributed datastores. These applications may include analytical search engines and collaboration laboratories. The resultant system is an onion services analysis system capable of extracting and storing a large scale amount of information from onion services, classifying the crawled onion domains and content thereof based on a property of interest, and using the stored data to support analytical applications such as an analytical search engine of darkweb onion domains.

Accordingly, the present disclosure provides improvements to the functionality of computing devices by offering a searchable database that sanitizes potentially malicious content to allow users to identify sources of the malicious content and shared features of multiple such onion sources without coming into contact with the actual malicious content (e.g., protecting computing devices and the users thereof). Additionally, due to the high latency of onion domains and difficulty of searching onion domains (which is a design feature of onion domains), the searchable database provided herein offers improvements to computing devices related to the speed and ease at which the onion domains may be searched. These and other benefits will be apparent to those of skill in the art, and may be realized by researchers, investigators, and others who deal with the darkweb.

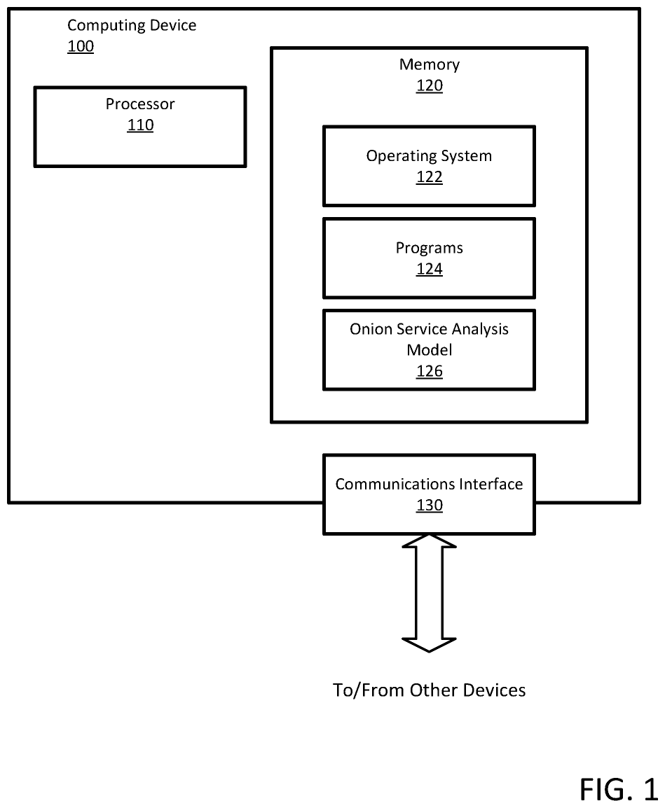

FIG. 1 illustrates a computing device 100 as may be uses as an onion service analysis system, according to aspects of the present disclosure. The computing device 100 may include at least one processor 110, a memory 120, and a communication interface 130.

The processor 110 may be any processing unit capable of performing the operations and procedures described in the present disclosure. In various embodiments, the processor 110 can represent a single processor, multiple processors, a processor with multiple cores, and combinations thereof.

The memory 120 is an apparatus that may be either volatile or non-volatile memory and may include RAM, flash, cache, disk drives, and other computer readable memory storage devices. Although shown as a single entity, the memory 120 may be divided into different memory storage elements such as RAM and one or more hard disk drives. As used herein, the memory 120 is an example of a device that includes computer-readable storage media, and is not to be interpreted as transmission media or signals per se.

As shown, the memory 120 includes various instructions that are executable by the processor 110 to provide an operating system 122 to manage various features of the computing device 100 and one or more programs 124 to provide various functionalities to users of the computing device 100, which include one or more of the features and functionalities described in the present disclosure. One of ordinary skill in the relevant art will recognize that different approaches can be taken in selecting or designing a program 124 to perform the operations described herein, including choice of programming language, the operating system 122 used by the computing device 100, and the architecture of the processor 110 and memory 120. Accordingly, the person of ordinary skill in the relevant art will be able to select or design an appropriate program 124 based on the details provided in the present disclosure.

One such program 124 may include an onion services analysis model 126, configured to perform the operations described herein. In various embodiments, the onion services analysis model 126 may be stored locally in the computing device 100 providing the onion services analysis system, or may be hosted by a different computing device 100, that the computing device 100 providing the onion services analysis system accesses via a network (via the communication interface 130) as a remotely-hosted service.

The communication interface 130 facilitates communications between the computing device 100 and other devices, which may also be computing devices as described in relation to FIG. 1. In various embodiments, the communication interface 130 includes antennas for wireless communications and various wired communication ports. The computing device 100 may also include or be in communication, via the communication interface 130, one or more input devices (e.g., a keyboard, mouse, pen, touch input device, etc.) and one or more output devices (e.g., a display, speakers, a printer, etc.).

Although not explicitly shown in FIG. 1, it should be recognized that the computing device 100 may be connected to one or more public and/or private networks via appropriate network connections via the communication interface 130. It will also be recognized that software instructions may also be loaded into a non-transitory computer readable medium, such as the memory 120, from an appropriate storage medium or via wired or wireless means.

Accordingly, the computing device 100 is an example of a system that includes a processor 110 and a memory 120 that includes instructions that (when executed by the processor 110) perform various embodiments of the present disclosure. Similarly, the memory 120 is an apparatus that includes instructions that, when executed by a processor 110, perform various embodiments of the present disclosure.

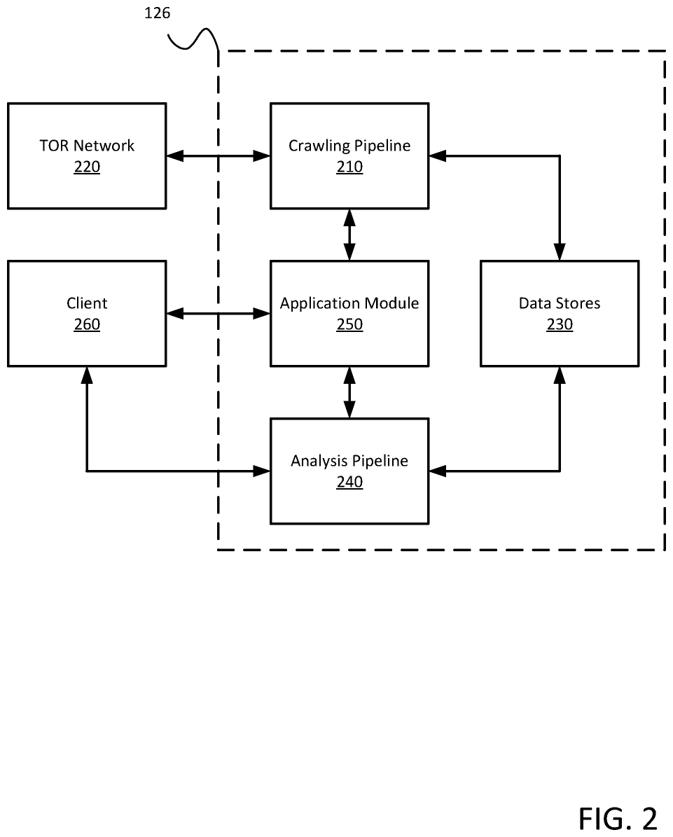

FIG. 2 illustrates an example embodiment of an onion service analysis model 126 according to embodiments of the present disclosure.

In an embodiment of the present disclosure, an onion service analysis model 126 includes a crawling pipeline 210. The crawling pipeline 210 interacts with a Tor network 220 using a cluster of auto-scaling Tor clients that allows for use of many different guard nodes when accessing the Tor network 220. The crawling pipeline 210 may include one or more crawlers of one or more varying type. These crawlers may be configured to visit onion domains and extract information on websites hosted by onion services. In some embodiments, the crawlers all share a job queue of onion domains to visit and a hash table that maps visited onion domains to extracted metadata therefrom, such as rendering parameters. Visited onion domains are added back to the queue to be recrawled in order to extract the most up-to-date information. In some embodiments, an initial seeding of the crawlers' queue of onion domains is sourced by parsing known onion indexers. The crawlers in the crawling pipeline 210 store the extracted information from each crawled onion domain in distributed datastores 230. The crawling pipeline 210 may also include components to render extracted content for analysis, such as a cluster of auto-scaling rendering engines. These crawlers and renderers may also extract and render image data hosted on onion domains.

In various embodiments, the crawlers enrich each domain using a set of cross-validated classifiers. This enrichment identifies whether a domain is visually and textually similar to other domains, hosts illicit content, tracks the users/visitors thereto, or accepts cryptocurrency payments or donations, in addition to domain category and language detection. Moreover, the crawlers use specialized hashing techniques to group similar images that are hosted on onion domains, and assigns these images to unique source cameras when possible. This classification allows the onion service analysis model 126 to identify onion domains that host similar images, or images that were captured by the same camera, without having to store likely-illicit image files. As will be appreciated, the ability to analyze domains that include malicious content, without being exposed to that malicious content, or being exposed to legal ramification for accessing, storing, or receiving malicious content can help researchers or investigators identify malicious parties while protecting the computing devices used by those researchers or investigators.

Three main challenges are unique to crawling onion services compared to regular internet services that the onion service analysis model 126 overcomes. First, the only way to discover new onion domains is to crawl onion web-pages, starting with some known seeds. While one might attempt to collect onion domains by recording directory service queries using modified Tor relays that meet the requirements to join the HS-Dir, this approach only works for version 2 (v2) onion services, and is generally considered malicious and impractical. Second, the Tor client is assigned the same guard node even if the Tor client connects to different onion services with their own circuits. As the guard node has a limited bandwidth, the guard node will reject new connection requests once the guard node reaches full capacity. As such, there is an inherent bottleneck in crawling onion services that introduces a hard limit on performance. Third, onion services host a wide range of illicit content that is sensitive, illegal, or malicious in nature. While common analysis tasks require access to raw data, especially images, storing such illicit data as part of the crawling process can expose operators to various risks.

Accordingly, the onion service analysis model 126 uses three types of crawlers to explore, update, and check the status of onion services. Each crawler type has a unique auto-scaling cluster to accommodate increased workloads on-demand, allowing the onion service analysis model 126 to crawl millions of onion webpages in a single day. The crawlers share a job queue containing onion URLs and a hash table that maps visited onion URLs to associated metadata, such as rendering parameters. This hash table is used to deduplicate visited URLs from the queue, recrawl visited URLs, and check the status of visited domains. The onion service analysis model 126 uses a seeding strategy that produces onion domains with diverse contents. In particular, the approach collects initial seeds by parsing known onion indexers, and the results of search queries from known onion search engines. For the latter source, the onion service analysis model 126 uses search terms that are generated from single words and 2-word combinations from different language dictionaries

The onion service analysis model 126 sends Hypertext Transfer Protocol (HTTP) requests through an Application Program Interface (API) provided by an auto-scaling cluster of rendering engines. Each renderer then relays requests to a daemon that is part of another auto-scaling cluster of Tor clients, allowing the pipeline to interact with the Tor network using many guard nodes. HTTP responses are sent back by each daemon to the originating renderer for execution, where for each response, the onion service analysis model 126 produces a raw HTML file and a rendered version thereof, along with other metadata, such as the response header and hashes of all images found in the rendered webpage, including a screenshot thereof. This rendered version is sanitized to protect the computing device of the user from malicious or illicit content included by the analyzed domain.

To use images for analysis without having to store those images, the onion service analysis model 126 uses difference and perceptual hashing to capture features/scenes of an image and photo-response non-uniformity (PRNU) noise hashing to fingerprint the source camera used to capture an image, if any. Finally, each rendered HTML file, along with the metadata, are parsed and transformed into a key-value document describing the crawled webpage, and is uniquely identified by the URL thereof. In various embodiments, the parsing includes one or more of extracting information from the response header, the onion domain, and the HTML markup itself, including URLs, images, JavaScript (JS), and Cascaded Style Sheets (CS S) code, either embedded or external, and cryptocurrency addresses. This document is then stored in a sharded search engine cluster, while all remaining files (e.g., namely raw/rendered HTML, JS, CSS, and image hash files) are stored in a distributed filestore for further analysis. All extracted onion URLs are pushed to the crawling job queue to explore new domains

In some embodiments, the onion service analysis model 126 includes an analysis pipeline 240. The analysis pipeline 240 may include different modules depending upon what the relevant property of interest entails. For example, an analysis pipeline 240 may include a content intelligence module that uses a plurality of artificial neural networks to classify onion domains based on a property of interest, such as language, illicitness status (e.g., whether the domain host illicit content), repetition status (e.g., whether multiple domains appear to host identical content), tracking status, or whether a domain explicitly attributes a cryptocurrency address to itself. In some embodiments, the analysis pipeline 240 includes a module for analyzing image data extracted from onion domains. In some embodiments, the analysis pipeline 240 includes a graph intelligence module, which processes the files in the distributed datastores 230 to construct a directed graph, where onion domains represent nodes and a link from one onion domain to another domain (e.g., whether an onion domain or a normal web domain) represent edges. This graph is stored in the distributed datastores 230 where the graph can be used for a variety of theoretical graph analyses. In some embodiments, the analysis pipeline 240 includes a module tracking whether an onion domain accepts cryptocurrency transactions and generating a graph based on the wallet of the domain and a transaction history of that wallet. As illustrated in FIG. 2, the analysis pipeline may be in communication with a client 260, such as a regular web browser to allow users to select among relevant properties for analysis.

Analyzing onion services introduces three main challenges. First, it is common for onion services to host the same website, some-times with minor changes, under different domain names, typically to improve anonymity and performance. Unlike the regular web, where it is possible to group different domains based on their subject alternative name (SAN) SSL certificate (i.e., a certificate with multiple host names), it is not possible to achieve this grouping at the protocol level in the Tor network due to mutual anonymity. Second, similar to crawling, onion services host a wide range of illicit content that is sensitive or illegal, which makes illicit content detection an essential part of the analysis, typically broken down by domain category. Third, onion services use cryptocurrencies as the default online payment method, mainly due to their privacy features. Unlike centralized methods, where personally identifiable financial transactions are collected and kept private, cryptocurrencies use (pseudo)anonymous identifiers, called addresses, that are shared by onion services to receive payments or donations through public blockchain transactions. In addition, onion services typically include such addresses in the HTML, markup as a regular text (i.e., without a unique syntax), making cryptocurrency address attribution to onion services another challenging, but essential, part of the analysis.

Accordingly, the onion service analysis model 126 groups documents generated by the crawling pipeline 210 by the onion domains. Instead of processing all of the documents that belong to a domain, the onion service analysis model 126 treats the document representing the homepage of the domain as a representative, and uses the homepage document along with the associated files (e.g., rendered HTML, JS, and CSS files) for feature extraction and classification. An exception to this rule is when the onion service analysis model 126 performs cryptocurrency address attribution, where an address can appear on any webpage of a domain, and thus all of the domain's documents and related files may get processed. As summarized in Table 1, the onion service analysis model 126 extracts various features for offline training and online evaluation of the following domain property classifiers.

TABLE 1

| Classifier | Description |
|---|---|
| Language | Identifies the main language of the domain |
| | among 50 supported languages using a Naive |
| | Bayes (NB) classifier |
| Illicitness | Identifies whether the domain hosts |
| | illegitimate and unsafe content using a |
| | Random Forests (RF) classifier |
| Category | Identifies the main category of the domain |
| | among six categories using an RF classifier |
| Template | Also referred to as a mirror domain classifier, |
| | identifies whether a domain is visually and |
| | textually similar to another domain using an |
| | NB classifier across all pairs of domains |
| Tracking | Identifies whether a domain tracks |
| | users/visitors with JS-based fingerprinting |
| | techniques using a Support Vector Machines |
| | (SVM) classifier |
| Attribution | Identifies whether a domain explicitly |
| | attributes a cryptocurrency address to itself, as |
| | a payment or donation address, using an RF |
| | classifier |

The categories may be further sub-divided as indicated in Table 2. The present disclosure contemplates that some onion services may be described by two or more categories (e.g., a pornography marketplace using cryptocurrency transactions, a social media site for sharing link lists to other onion domains), and that the classifier may assign two or more category labels to an onion service or assign a “primary” category to an onion service. This primary category may be based on a hierarchy of interest of the categories (e.g., any service identified as category A, regardless of other identified categories is labeled as category A) or a confidence level in assigning the category (e.g., the highest confidence in assigning a given category type). The present disclosure also contemplates that other categories beyond those shown in Table 2 may be developed, which may include combinations of the identified categories (e.g., “social media+pornography”), subcategories of the identified categories (e.g., “social media+includes video”, “social media+related to politics”), or newly developed categories (e.g., “log in required” or a sub-cluster identified within the “other” category). Accordingly, the examples presented in Table 2 are given for illustrative purposes, and are not intended to be limiting to the categories of how the onion service analysis model 126 may categorize onion services.

TABLE 2

| Category | Description |
|---|---|
| Social Media | A platform for user to share and discuss |
| | content |
| Marketplace | An e-commerce website to buy or sell |
| | merchandise |
| Pornography | A catalog of pornographic photos, videos, |
| | novels, etc. |
| Indexer | A search engine or link list for various onion |
| | domains |
| Crypto | A service that relies on cryptocurrency |
| | transactions |
| Other | A website that does not fit, or has not yet been |
| | categorized, into another category |

The extracted features are stored in a distributed, relational database and are uniquely identified by the corresponding onion domain. These features are updated only if the domain is found to host new content, as indicated by the crawling pipeline 210 during an update run. The trained classifiers and the ground truth datasets thereof are stored in the filestore for subsequent online deployment and retraining. In contrast, classifiers' outputs for each onion domain are stored in the relational database, in addition to updating the corresponding documents in the search engine's index to support custom search filters by domain properties.

In various embodiments, the classifiers used by the onion service analysis model 126 to group documents generated by the crawling pipeline 210 may be trained according to the models and parameters set forth in Table 3. As will be appreciated, other training schemes may be employed, using training datasets with different ground truths or numbers of examples, although the stated training schemes have been found via experiment to be particularly effective in the stated goals of the onion service analysis model 126.

TABLE 3

| | | Ground-Truth | | |
|---|---|---|---|---|
| | | Dataset | | |
| Classifier | Model | Description | AUC | % (class) |
| Category | Random Forest (RF) | 8,881 rendered homepages | 0.99 ± 0.01 | 0.418 (social media |
| | with One-vs-Rest | | | 29.50 (marketplace) |
| | (OvR) multiclass | | | 10.81 (pornography) |
| | strategy | | | 05.81 (indexer) |
| | | | | 03.83 (crypto) |
| | | | | 45.87 (other) |
| Language | NB with OvR | 10M Wikipedia | 0.97 ± 0.02 | 00.02 (each language) |
| | | abstracts in 50 | | |
| | | languages | | |
| Camera | AHC-PCE with OvR | 2479 image | 0.84 ± 0.07 | 07.69 (each camera) |
| | | PRNU hash | | |
| | | pairs from 13 | | |
| | | cameras | | |
| Illicitness | RF | 8,881 rendered | 0.97 | 55.91 (illicit) |
| | | home pages | | |
| Template | NB | 1032 pairs of | 0.99 | 13.90 (templated) |
| | | rendered | | |
| | | homepages | | |
| Tracking | SVM | 1739 rendered | 0.95 | 35.50 (tracked) |
| | | homepages | | |
| Attribution | RF | 2726 rendered | 0.99 | 57.48 (attributed) |
| | | webpages | | |
| Image | AHC-HD | 15k image | 0.98 | 43.63 (similar images) |
| | | perceptual hash | | |
| | | pairs | | |
| Wallet | IF | 1k Bitcoin | 0.96 | 05.00 (outlier wallets) |
| | | wallets and | | |
| | | associated | | |
| | | transactions | | |

In various embodiments, the onion service analysis model 126 processes all image hash files of each domain, both perceptual and PRNU, to identify similar images and source cameras if possible. Before that, however, the onion service analysis model 126 filters out all images with size that satisfies a first threshold (e.g., ≤64 pixels), as these images typically represent icons, logos, and synthetic images. For the first task, the onion service analysis model 126 uses perceptual hashing as the onion service analysis model 126 outputs a similar hash value of an image after the image goes through typical transformation and alteration, such as resizing, cropping, blurring, or gamma correction. In some embodiments, the onion service analysis model 126 uses an image classifier that identifies whether an image is similar to another using agglomerative hierarchical clustering (AHC) across all pairs of images, where hamming distance (HD) is used as a similarity measure.

As for the second task, the onion service analysis model 126 starts by filtering out all images with size that satisfies a second threshold (e.g., ≤100×100 pixels), as these images typically represent previews and thumbnails. The onion service analysis model 126 uses PRNU hashing because each camera creates a highly characteristic pattern caused by differences in material properties and proximity effects during the production process of the camera's image sensor. Accordingly, the onion service analysis model 126 uses a camera classifier that identifies whether an image was captured by the same camera used to capture another image using AHC across all pairs of images, where peak to correlation energy (PCE) is used as a similarity measure.

Finally, the outputs of the image and camera classifiers for each onion domain are stored in the relational database, in addition to updating the corresponding documents in the search engine's index to support reverse image search (RIS).

The onion service analysis model 126 processes all documents of each domain to construct a directed graph, where a node represents a domain and an edge represents a URL to a domain from another. Moreover, each node has a binary attribute indicating whether it is an onion (type-1) or a regular web (type-2) domain. As such, edges represent URLs to onion or regular web domains from onion domains, where the source node is always a type-1 node. This graph is stored in a distributed graph database that enables fast execution of graph-theoretic algorithms. In some embodiments, the onion service analysis model 126 runs four analytical tasks every time the graph structure changes: Summary statistics, bow-tie decomposition, and centrality measures using type-1 subgraph, and dark-to-regular web linking using the whole graph.

While the first three analytical tasks are solely graph-theoretic and have existing algorithms, the fourth task involves analyzing which onion services interact with possibly malicious domains on the regular web. To achieve this, the onion service analysis model 126 uses a malicious domain intelligence feed. The malicious domain intelligence feed provides aggregated URL intelligence by consulting over third-party anti-virus tools and URL/domain reputation services, where each tool may be referred to as a “scanner”. A primary measure of maliciousness from the intelligence feed is the number of scanners that mark a URL as malicious. The higher this value is for a given URL, the more likely the URL is malicious. In some embodiments, the onion service analysis model 126 treats a given URL as malicious if more than a threshold number (e.g., at least one) of scanners identify the URL as malicious.

The outputs of these tasks are stored in the relational database, where node-specific information, such as centrality and topological location in the graph, can be used for further analysis.

In various embodiments, the onion service analysis model 126 runs a cluster of various cryptocurrency daemons to connect to and synchronize with public blockchains, such as Bitcoin and Ethereum. Each daemon represents a full client node with a native RPC API support. The onion service analysis model 126 implements a high-throughput parallel parser that fetches blocks from daemons and then transforms each block, including its embedded transactions and addresses, to a format that is optimized for storage and analysis in the relational and graph databases.

The onion service analysis model 126 clusters the addresses used by each cryptocurrency into wallets using well-known algorithms, such as the multiple-input and deposit address clustering heuristics. After that, the onion service analysis model 126 filters out outlier wallets that have a significantly larger wallet size and money flow using an Isolation Forest (IF) classifier, even if some of these addresses are self-attributed by onion services. The wallets are then stored in the relational database for further analysis. The onion service analysis model 126 also creates a directed graph where a node represents a wallet and an edge represents one or more transactions whose inputs and outputs contain any of the addresses found in source and destination wallets, respectively. Moreover, each edge has two attributes specifying the number of transactions and the total amount of transferred money. This wallet graph is stored in the graph database to allow efficient money flow-related queries, such as computing the total deposits and withdrawals of a wallet in a fiat currency.

For each cryptocurrency address that has a mapping to an onion domain by the attribution classifier, the onion service analysis model 126 updates the corresponding wallet(s) in the relational database with these attributions as textual labels, in addition to the documents in the search engine's index for fast wallet lookups. In other words, each wallet is labelled by the onion domains which self-attribute any of the addresses thereof.

In some embodiments, the onion service analysis model 126 includes an application module 250. The application module 250 may host one or more applications that assist in determining a property of interest. For example, the application module 250 hosts an analytical search engine that provides results based on the information in the distributed datastores 230. As illustrated in FIG. 2, the application module 250 may be accessible by a client 260, such as a regular web browser.

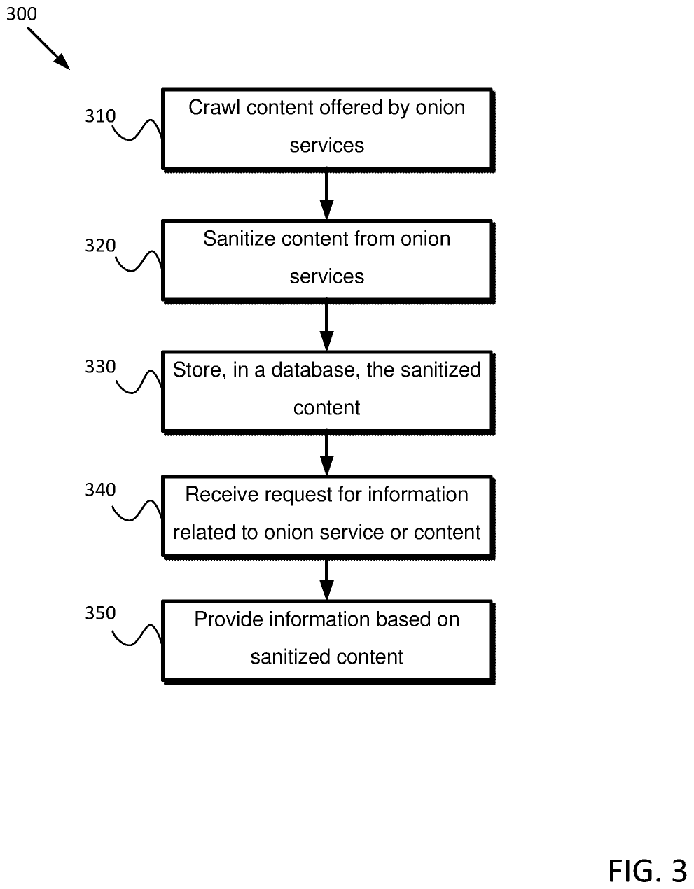

FIG. 3 is a flowchart of an example method 300 of providing scalable darkweb analytics, according to embodiments of the present disclosure. Method 300 begins a block 310 where the onion services analysis model 126 crawls content offered by a plurality of onion services to build a searchable database of those domains.

At block 320, the onion services analysis model 126 sanitizes the content from each onion service of the plurality of onion services into sanitized content that represents potentially malicious content in a non-malicious form. In various embodiments, the content included in some or all of the onion services include malicious content, such as illicit images or viruses, that can be dangerous or illegal to store on a destination computing device, but the general type or content classification may be useful to ascertain for research purposes, as is the ability to identify matching content across different onion services. In various embodiments, to allow for generalization and to permit matching across different onion services, the content are sanitized by hashing the content via different and perceptual hashing techniques to captures features or scenes present in images. In various embodiments, to increase computational speed (and reduce consumption of computing resources, including bandwidth in a bandwidth-restricted onion connection) the sanitization operations include pre-filtering operations that omit content from sanitization that are below a given number of pixels or file size. In various embodiments, the pre-filtered content may be omitted from storage or included in storage in an unfiltered status.

In various embodiments, as part of sanitizing any images, the images may be fingerprinted to identify a source camera, which may be associated with the sanitized data to identify when multiple images can be associated with a given camera (and potentially an owner thereof). In various embodiments, the fingerprinting may be performed via photo-response non-uniformity (PRNU) noise hashing.

At block 330, the onion services analysis model 126 stores, in a database, the sanitized content in association with a unique identity for each onion service of the plurality of onion services. As the potentially illicit images and other malicious files are sanitized before storage, an operator may safely (and more rapidly) search the downloaded and sanitized data than individually searching for the content via an onion connection to the various onion services.

At block 340, the onion services analysis model 126 receives a request for information related to a given onion service of the plurality of onion services or content offered thereby. In various embodiments, the query may request a URL, a content type, a content descriptor (e.g., text on a webpage), a wallet address, a fingerprint of a given camera, and the like. In various embodiments, the request for information may include a reverse image search request, in which a queried-for image is processed according to the sanitization procedures (e.g., per block 320) to generate various query terms based on the sanitized output of the queried-for image. For example, the system may extract query terms from the sanitized/fingerprinted queried-for image that include the source camera, a content type, scene data, feature data, matching hashes, and the like.

At block 350, the onion services analysis model 126 provides, in response to the request, the information based on the sanitized content. In various embodiments, the response may include URLs, cryptocurrency wallet information, counts of unique URLs with the requested information and the like.

Certain terms are used throughout the description and claims to refer to particular features or components. As one skilled in the art will appreciate, different persons may refer to the same feature or component by different names. This document does not intend to distinguish between components or features that differ in name but not function.

As used herein, the term “optimize” and variations thereof, is used in a sense understood by data scientists to refer to actions taken for continual improvement of a system relative to a goal. An optimized value will be understood to represent “near-best” value for a given reward framework, which may oscillate around a local maximum or a global maximum for a “best” value or set of values, which may change as the goal changes or as input conditions change. Accordingly, an optimal solution for a first goal at a given time may be suboptimal for a second goal at that time or suboptimal for the first goal at a later time.

As used herein, “about,” “approximately” and “substantially” are understood to refer to numbers in a range of the referenced number, for example the range of −10% to +10% of the referenced number, preferably −5% to +5% of the referenced number, more preferably −1% to +1% of the referenced number, most preferably −0.1% to +0.1% of the referenced number.

Furthermore, all numerical ranges herein should be understood to include all integers, whole numbers, or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in the present disclosure, a phrase referring to “at least one of” a list of items refers to any set of those items, including sets with a single member, and every potential combination thereof. For example, when referencing “at least one of A, B, or C” or “at least one of A, B, and C”, the phrase is intended to cover the sets of: A, B, C, A-B, B-C, and A-B-C, where the sets may include one or multiple instances of a given member (e.g., A-A, A-A-A, A-A-B, A-A-B-B-C-C-C, etc.) and any ordering thereof. For avoidance of doubt, the phrase “at least one of A, B, and C” shall not be interpreted to mean “at least one of A, at least one of B, and at least one of C”.

As used in the present disclosure, the term “determining” encompasses a variety of actions that may include calculating, computing, processing, deriving, investigating, looking up (e.g., via a table, database, or other data structure), ascertaining, receiving (e.g., receiving information), accessing (e.g., accessing data in a memory), retrieving, resolving, selecting, choosing, establishing, and the like.

Without further elaboration, it is believed that one skilled in the art can use the preceding description to use the claimed inventions to their fullest extent. The examples and aspects disclosed herein are to be construed as merely illustrative and not a limitation of the scope of the present disclosure in any way. It will be apparent to those having skill in the art that changes may be made to the details of the above-described examples without departing from the underlying principles discussed. In other words, various modifications and improvements of the examples specifically disclosed in the description above are within the scope of the appended claims. For instance, any suitable combination of features of the various examples described is contemplated.

Within the claims, reference to an element in the singular is not intended to mean “one and only one” unless specifically stated as such, but rather as “one or more” or “at least one”. Unless specifically stated otherwise, the term “some” refers to one or more. No claim element is to be construed under the provision of 35 U.S.C. § 112(f) unless the element is expressly recited using the phrase “means for” or “step for”. All structural and functional equivalents to the elements of the various embodiments described in the present disclosure that are known or come later to be known to those of ordinary skill in the relevant art are expressly incorporated herein by reference and are intended to be encompassed by the claims. Moreover, nothing disclosed in the present disclosure is intended to be dedicated to the public regardless of whether such disclosure is explicitly recited in the claims.

The invention is claimed as follows:

1. An onion service analysis system comprising:
a memory; and
a processor in communication with the memory, the processor configured to:
execute an onion service analysis model, wherein the onion service analysis model comprises a crawling pipeline, an analysis pipeline, and a distributed datastore;
extract information from onion services using the crawling pipeline;
store the extracted information in the distributed datastore;
analyze the stored extracted information using the analysis pipeline of the onion service analysis model; and
determine a first property based on the analyzed information.

2. The system of claim 1, wherein the onion service analysis model further comprises an applications module, and wherein the processor is further configured to run at least one application hosted with the applications module.

3. The system of claim 1, wherein the onion service analysis model further comprises an applications module, and wherein the processor is further configured to run an analytical search engine hosted with the applications module.

4. The system of claim 1, wherein the first property includes a language of an onion service.

5. The system of claim 1, wherein the first property includes an illicitness status.

6. The system of claim 1, wherein the first property includes an onion services' cryptocurrency address.

7. The system of claim 1, wherein the analysis pipeline includes a plurality of artificial neural networks.

8. The system of claim 1, wherein the processor is further configured to determine a second property based on the analyzed information.

9. A method, comprising:
crawling content offered by a plurality of onion services;
sanitizing the content from each onion service of the plurality of onion services into sanitized content that represents potentially malicious content in a non-malicious form;
storing, in a database, the sanitized content in association with a unique identity for each onion service of the plurality of onion services;
receiving a request for information related to a given onion service of the plurality of onion services; and
providing, in response to the request, the information based on the sanitized content.

10. The method of claim 9, wherein the malicious content includes images that are sanitized by:
hashing the images via difference and perceptual hashing to capture features/scenes present in the images.

11. The method of claim 9, wherein the malicious content includes illicit images.

12. The method of claim 9, further comprising:
pre-filtering images included in the content that are below a given number of pixels to omit from the content that is sanitized.

13. The method of claim 9, further comprising:
fingerprinting a source camera for any images in the content via photo-response non-uniformity (PRNU) noise hashing.

14. The method of claim 9, further comprising:
wherein the request for information includes a reverse image search request.

15. A non-transitory computer readable device including instructions that, when executed by a processor, perform operations comprising:
crawling content offered by a plurality of onion services;
sanitizing the content from each onion service of the plurality of onion services into sanitized content that represents potentially malicious content in a non-malicious form;
storing, in a database, the sanitized content in association with a unique identity for each onion service of the plurality of onion services;
receiving a request for information related to a given onion service of the plurality of onion services; and
providing, in response to the request, the information based on the sanitized content.

16. The device of claim 15, wherein the malicious content includes images that are sanitized by:
hashing the images via difference and perceptual hashing to capture features/scenes present in the images.

17. The device of claim 15, wherein the malicious content includes illicit images.

18. The device of claim 15, the operations further comprising:
pre-filtering images included in the content that are below a given number of pixels to omit from the content that is sanitized.

19. The device of claim 15, the operations further comprising:
fingerprinting a source camera for any images in the content via photo-response non-uniformity (PRNU) noise hashing.

20. The device of claim 15, the operations further comprising:
wherein the request for information includes a reverse image search request.
